(19) United States
(12) Patent Application Publication
(10) Pub. No.: US 2025/0352834 A1
(43) Pub. Date: Nov. 20, 2025

(54) RESPIRATOR VALVE PROP APPARATUS

(71) Applicant: OHD, LLLP, Birmingham, AL (US)

(72) Inventors: Michael Hicks, Hoover, AL (US); Sean Simmons, Hoover, AL (US)

(73) Assignee: OHD, LLLP, Birmingham, AL (US)

(21) Appl. No.: 19/208,110

(22) Filed: May 14, 2025

Related U.S. Application Data
(60) Provisional application No. 63/647,577, filed on May 14, 2024.

(51) Int. Cl. A62B 27/00

(52) U.S. Cl. CPC A62B 27/00

(57) ABSTRACT

The present disclosure provides an apparatus and methods for opening a valve of a respirator for respirator fit testing. An apparatus may include: a first end, wherein the first end comprises a cavity, wherein the cavity is configured to receive a male post of an adapter; a second end, wherein the second end comprises at least one protrusion; and an internal flange, wherein the internal flange comprises an interlocking feature, wherein the interlocking feature is configured to interact with at least one circumferential groove spaced axially along the male post to establish at least one adjustable height; wherein the apparatus rotates clockwise or counterclockwise until the at least one protrusion is engaged with the valve, a valve housing, or a cross section within housing.

### CROSS-REFERENCE TO RELATED APPLICATION

This application claims the benefit of U.S. Provisional Application No. 63/647,577, filed May 14, 2024, entitled RESPIRATOR VALVE PROP APPARATUS.

### FIELD OF THE INVENTION

This disclosure generally relates to the field of respirators, and more particularly, devices and methods of opening a valve of a respirator for respirator fit testing.

### BACKGROUND

The use of respirators is required by several national and international standards, including the Occupational Safety and Health Administration (OSHA) in the United States, when hazardous substances in the air cannot be controlled to an acceptable level for the health of employees. As a result, millions of individuals who may encounter inhalation hazards on the job rely on respirators.

According to OSHA, to ensure a respirator provides an appropriate level of protection, it is necessary that employers develop and maintain a respiratory protection program, of which respirator fit testing is a core concept. A respirator fit test evaluates the fit of a respirator to a wearer. A respirator fit test may ensure a respirator wearer is using an appropriate model, style, and size respirator, as tight-fitting respirators are necessary to avoid health concerns caused by the inhalation of contaminants due to poor seals, fittings, and other complications. Properly and tight-fitting respirators are necessary to avoid health concerns caused by the inhalation of contaminants due to poor seals, fittings, and other complications.

Fit testing may be performed qualitatively using a test agent detectable by the wearer, such as via the wearer's sense of taste, smell, or reaction to an irritant. Fit testing may also be performed quantitatively using an instrument to measure leakage of a test agent.

A majority of respirators have an exhalation valve that re-directs the user's breath during exhalation and an inhalation valve that opens when a user breathes to allow air to flow freely into the respirator through filters. It is important during respirator fit testing to prop at least one valve open to ensure continuous air flow during a fit test. If a valve is not propped open, the valve will close during testing, which will interfere with the negative pressure check used in some fit testing methods, and the test will most likely fail or abort.

### BRIEF SUMMARY

The present disclosure provides an apparatus for opening a valve of a respirator for respirator fit testing including: an apparatus for opening a valve of a respirator for respirator fit testing, comprising: a first end, wherein the first end comprises a cavity or central bore, wherein the cavity is configured to receive a male post of an adapter; a second end, wherein the second end comprises at least one protrusion; and an internal flange, wherein the internal flange comprises an interlocking feature, wherein the interlocking feature is configured to interact with at least one circumferential groove spaced axially along the male post to establish at least one adjustable height; wherein the apparatus rotates clockwise or counterclockwise until the at least one protrusion is engaged with the valve, a valve housing, or a cross section within housing.

The present disclosure provides a method of opening a valve of a respirator for respirator fit testing. The present disclosure further provides a kit including: an adapter having a male post, wherein the adapter removably attaches to a respirator; and an apparatus comprising a first end, wherein the first end comprises a cavity or central bore, wherein the cavity is configured to receive the male post; a second end, wherein the second end comprises at least one protrusion; and an internal flange, wherein the internal flange comprises an interlocking feature, and wherein the interlocking feature is configured to interact with at least one circumferential groove spaced axially along the male post to establish at least one adjustable height.

### DESCRIPTION OF THE DRAWINGS

It is to be understood that both the foregoing summary and the following drawings and detailed description may be exemplary and may not be restrictive of the aspects of the present disclosure as claimed. Certain details may be set forth to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The present disclosure may be better understood by reference to the accompanying drawing sheets, in which:

FIG. 1 includes an adapter in accordance with certain aspects of the present disclosure.

FIG. 2 includes a valve prop apparatus in accordance with certain aspects of the present disclosure.

FIG. 3A includes a valve prop apparatus inserted into an adapter in accordance with certain aspects of the present disclosure.

FIGS. 3B and 4 include a valve prop apparatus inserted into an adapter in accordance with certain aspects of the present disclosure, wherein the adapter is shown in dashed line.

FIGS. 5-7 include a cross section view of a valve prop apparatus inserted into an adapter in accordance with certain aspects of the present disclosure, wherein the valve prop apparatus is engaged with a male post of the adapter at different positions to provide for an adjustable height of a protrusion on the apparatus configured to open a valve on a respirator.

FIG. 8 includes an adapter in accordance with certain aspects of the present disclosure.

FIGS. 9A and 9B include a cross section view of a valve prop apparatus in accordance with certain aspects of the present disclosure.

FIG. 9C includes a view of the first end of the valve prop apparatus in accordance with certain aspects of the present disclosure.

FIG. 10A includes an adapter in accordance with certain aspects of the present disclosure.

FIG. 10B includes a valve prop apparatus in accordance with certain aspects of the present disclosure.

FIG. 11A includes an adapter in accordance with certain aspects of the present disclosure.

FIG. 11B includes a valve prop apparatus in accordance with certain aspects of the present disclosure.

FIGS. 12A and 12B include top and bottom views, respectively, of an adapter in accordance with certain aspects of the present disclosure.

FIGS. 12C and 12D include a valve prop apparatus according to certain aspects of the present disclosure.

FIGS. 13A and 13B include an adapter and valve prop apparatus attached to a respirator in accordance with certain aspects of the present disclosure.

### DETAILED DESCRIPTION

This disclosure generally describes a valve prop apparatus for opening a valve of a respirator for respirator fit testing. The disclosure further provides methods for opening a valve of a respirator for respirator fit test using a valve prop apparatus of the present disclosure. The present disclosure provides kits including a valve prop apparatus, an adapter for a respirator, and/or a converter capable of attaching to an adapter and a respirator.

It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by this disclosure. Further, any features, aspects, and advantages that may be present in the prior art may be affirmatively disclaimed. Accordingly, this disclosure may comprise, consist of, consist essentially of, or be characterized by one or more of the features, aspects, and advantages described herein.

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “Controlled Negative Pressure” or “CNP” refers to a quantitative fit testing method utilizing negative pressure as a direct measure of respirator leakage using air as the test challenge agent. CNP is based on exhausting air from a temporarily sealed respirator facepiece to generate and then maintain a constant negative pressure inside the facepiece, wherein the rate of air exhaust is controlled such that a constant negative pressure is maintained in the respirator during the fit test. With constant pressure, air flow out of the respirator is equal to air flow into the respirator.

As used herein, the term “adapter” may be used to refer to any device capable of attaching and/or connecting a respirator to a fit testing device.

As used herein, the term “valve” may be used to refer to any valve of a respirator, including, but not limited to, a butterfly-type popper valve, an exhalation valve, a diaphragm-type valve, a controlled air valve, an inhalation valve, and the like. A valve may include one or more partitions or spokes extending radially from a central axis of the valve.

As used herein, the term “respirator” refers to, but is not limited to, a tight-fitting respirator, an air-purifying respirator, a supplied-air respirator, an elastomeric half facepiece respirator, an elastomeric full facepiece respirator, a filtering facepiece respirator, a powered air-purifying respirator, a supplied-air respirator, a self-contained breathing apparatus, or a combination respirator.

U.S. Pat. No. 8,528,559 entitled “RESPIRATOR FIT-TESTING APPARATUS AND METHOD” and U.S. Pat. No. 8,011,368 entitled “RESPIRATOR FIT-TESTING APPARATUS AND METHOD” are hereby incorporated by reference in their entirety.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean nay of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a,” “an,” and “the” may be intended to include the plural forms as well, unless the context clearly dictates otherwise. As example, “a” valve may comprise one or more valves, and the like.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given aspect reciting compositions, materials, components, elements, features, integers, operations, and/or process steps, described herein also specifically includes aspects consisting of, or consisting essentially of, such recited compositions, materials, components, elements, features, integers, operations, and/or process steps. In the case of “consisting of”, the alternative aspect excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an aspect, but any compositions, materials, components, elements, features, integers, operations, and/or process steps that do not materially affect the basic and novel characteristics may be included in the aspect.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example aspects may be combined in or with various other example aspects in any permutational or combinatory manner. Different aspects or elements of example aspects, as disclosed herein, may be combined in a similar manner. The term “combination,” “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Words such as “then,” “next,” etc. are not intended to limit the order of the steps; these words may be simply used to guide the reader through the description of the methods.

In the description, certain details are set forth to provide a better understanding of various aspects of the systems and methods disclosed herein. However, one skilled in the art will understand that these aspects may be practiced without these details and/or in the absence of any details not described herein. In other instances, well-known structures, methods, and/or techniques associated with methods of practicing the various aspects may not be shown or described in detail to avoid unnecessarily obscuring descriptions of other details of the various aspects.

While specific aspects of the disclosure have been provided hereinabove, the disclosure may, however, be embodied in many different forms and should not be construed as necessarily being limited to only the aspects disclosed herein. Rather, these aspects may be provided so that this disclosure is thorough and complete and fully conveys various concepts of this disclosure to skilled artisans.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example aspects may be combined and sub-combined in and/or with various other example aspects. Also, different aspects and/or elements of example aspects, as disclosed herein, may be combined and sub-combined in a similar manner as well. Further, some example aspects, whether individually and/or collectively, may be components of a larger system, wherein other procedures may take precedence over and/or otherwise modify their application. Additionally, a number of steps may be required before, after, and/or concurrently with example aspects, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular aspects have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application, including the appended claims, is therefore intended to cover all such changes and modifications that may be within the scope of this application.

### DESCRIPTION

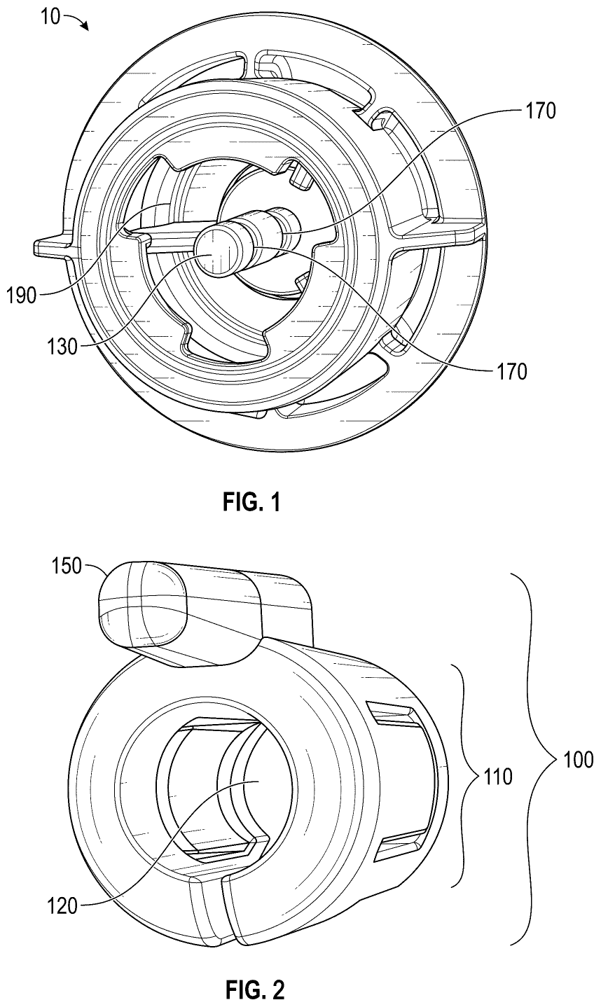

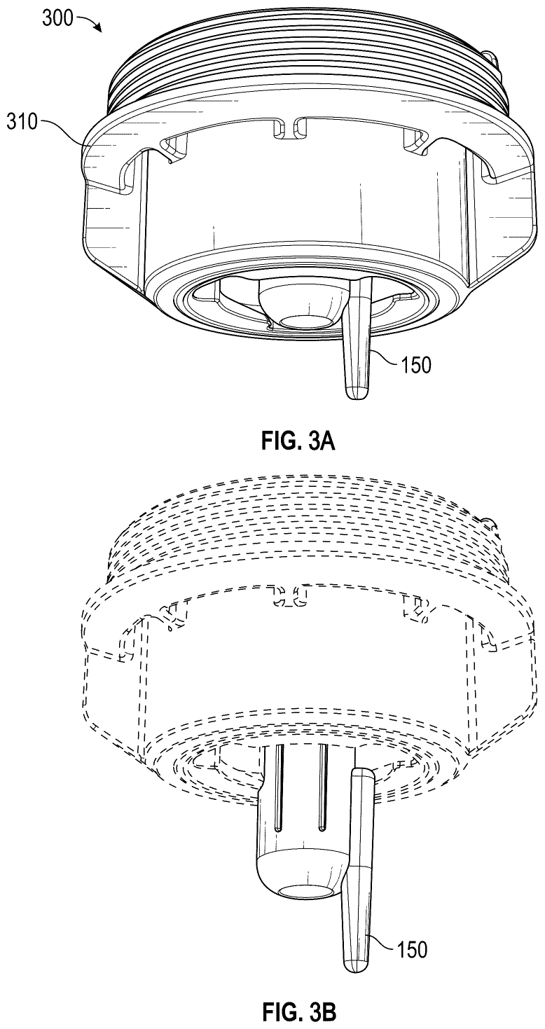

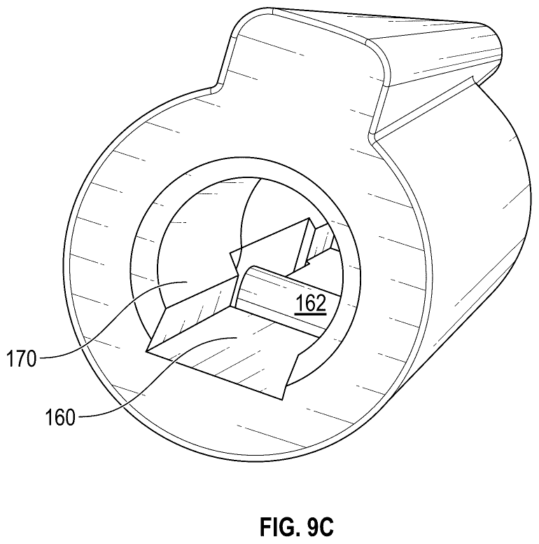

The present disclosure provides an apparatus for opening a valve of a respirator for respirator fit testing. The apparatus 100 may include a first end 110 having a central bore or cavity 120 (FIG. 2). The cavity 120 may be configured to receive a male post 130 of an adapter 10 (FIG. 1, FIG. 8). The apparatus 100 includes a second end 140 opposite the first end 110 that includes at least one protrusion 150. While a cylindrical male post 130 on the adapter 10 is shown in FIG. 1, other shapes and sizes of male post 130 are possible and within the scope of the present disclosure.

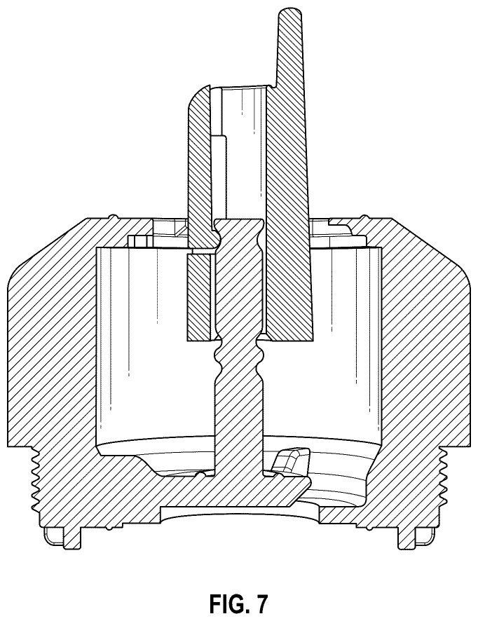

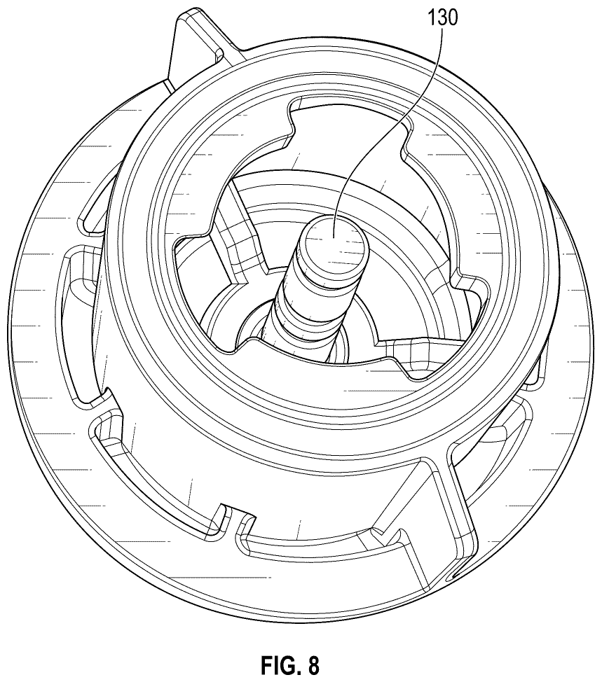

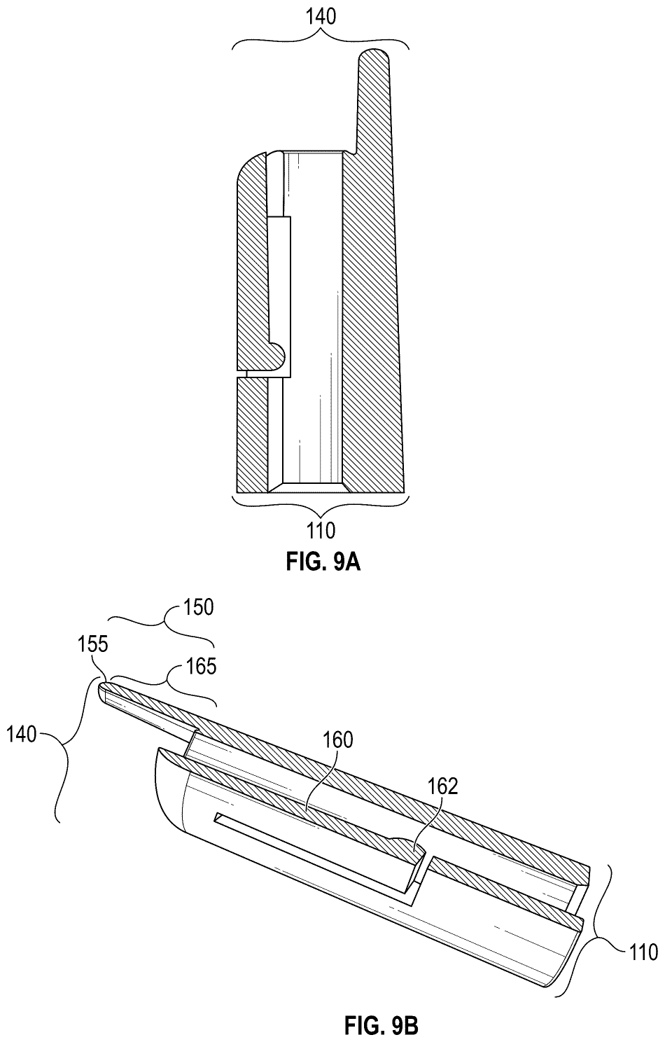

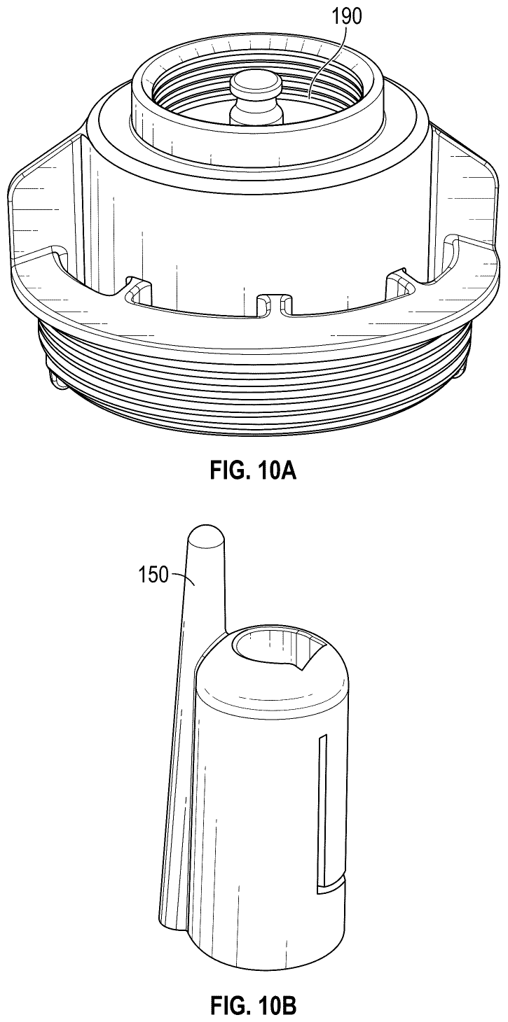

The apparatus 100 may include an internal flange 160 (scc FIGS. 9B and 9C), wherein the internal flange may include an interlocking feature 162, wherein the interlocking feature 162 may be configured to interact with at least one circumferential groove 170 spaced axially along the male post 130 of the adapter 10 to establish at least one adjustable height (see FIGS. 5-7) of the protrusion 150. The male post 130 may include a plurality of circumferential grooves 170 that may be uniformly spaced apart along the male post 130, or that need not be uniformly spaced from one another. Each circumferential groove 170 may be different distances from each other to increase the likelihood of the valve prop apparatus fitting into the valve housing cross sections of a respirator.

While a plurality circumferential grooves 170 are described, it is possible and within the scope of the present disclosure for the male post to not include circumferential grooves. Thus, the male post may not have circumferential grooves, or may include only a single circumferential groove, such that the male post may provide a single height. The apparatus may snap into place in a snap fit action known in the art. As a non-limiting example, a snap fit action may include a snap fit joint having at least one cantilever arm having an interlocking feature. The at least one cantilever arm may be deformed. The interlocking feature may be configured to snap into place and return the at least one cantilever arm to its original shape after insertion. After insertion, the interlocking feature may be in an engaged position.

The adapter 10 may include a raised bearing ring 12 at a distal end of the adapter.

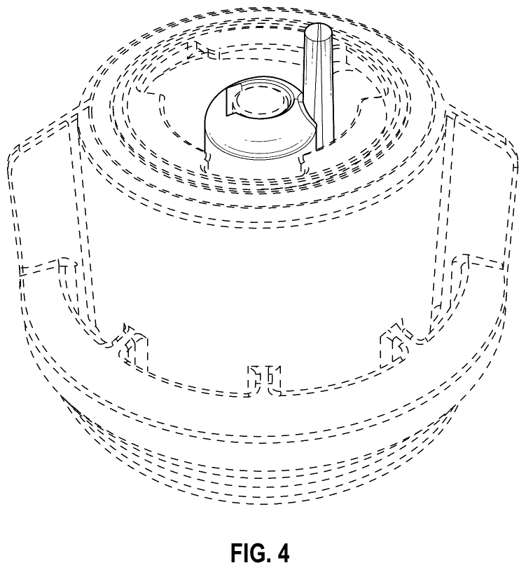

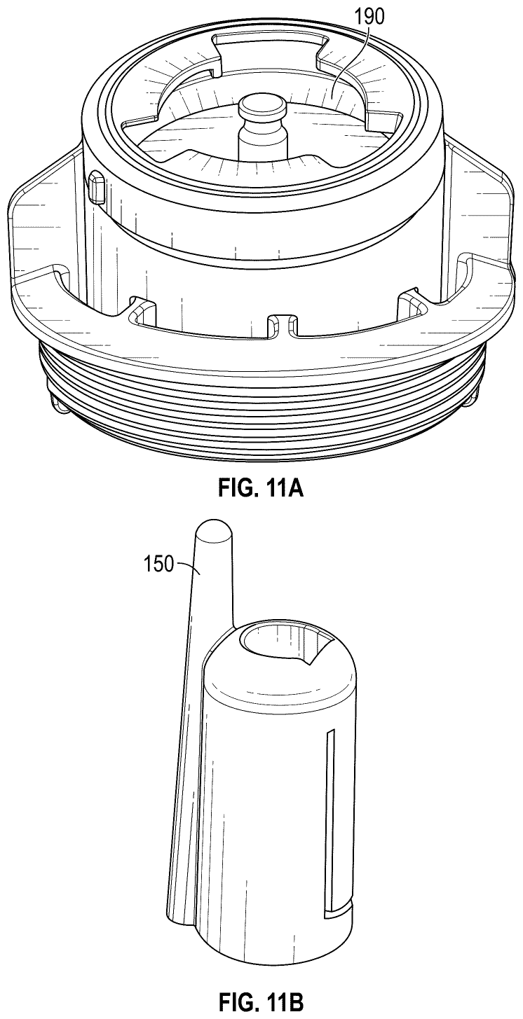

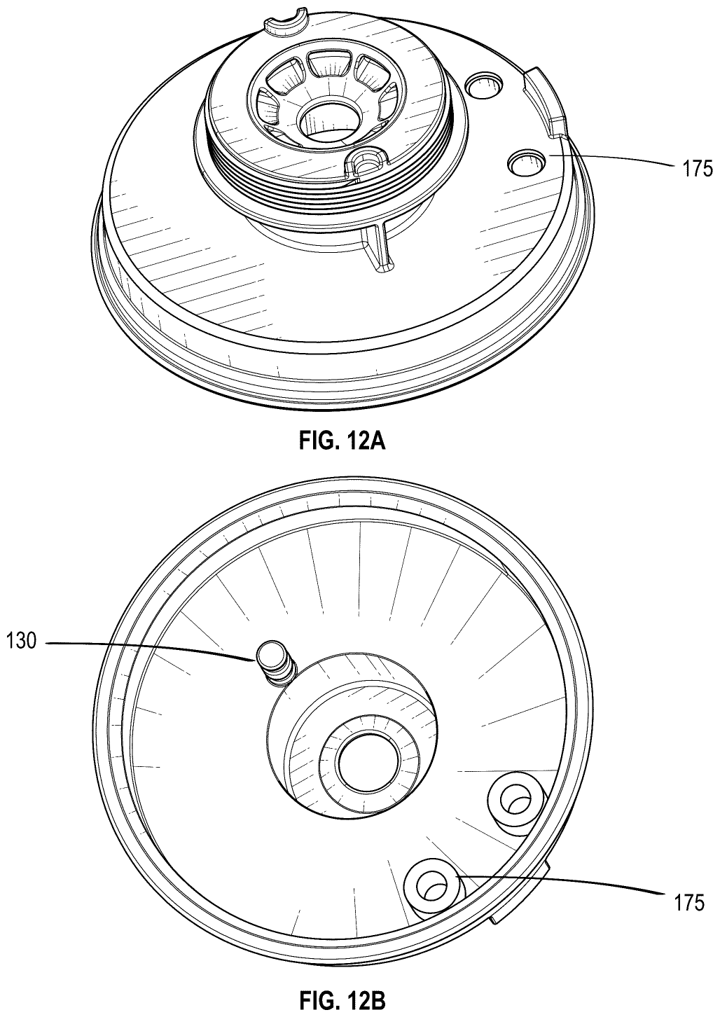

The first end 110 of the apparatus 100 may be configured to attach to an adapter 10 for a respirator. The first end 110 may removably attach to the male post 130 of an adapter (FIGS. 3A-7). As a non-limiting example, the male post 130 may include one or more circumferential grooves spaced axially along the male post 130. The adapter 10 may include a first adapter end and a second adapter end. The first adapter end may include an opening 190 wherein the apparatus may be inserted onto the male post. The opening 190 may be of any shape necessary to conform to the shape of the valve to be opened. As a non-limiting example, the opening may be circular (FIG. 10A). As a non-limiting example, the opening may be a shape as demonstrated in FIG. 1 and FIG. 11A. The size, shape, and orientation of the opening of the adapter may depend on the respirator type, or size, shape, and orientation of the valve, valve housing, or valve cross-sections.

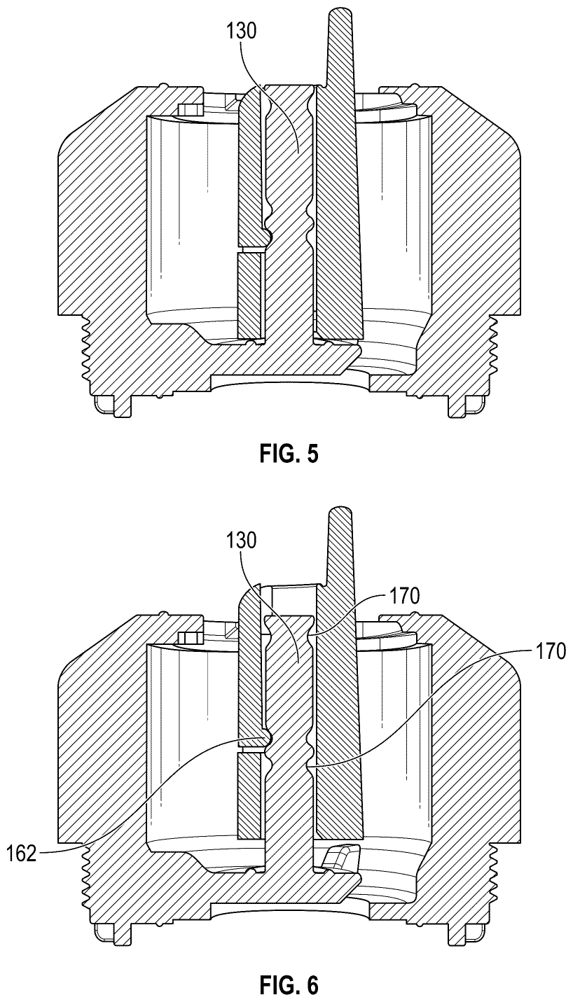

After insertion of the male post 130 in the cavity 120 of the apparatus 100, and the interlocking feature 162 of the internal flange 160 is secured in a circumferential groove 170, the valve prop apparatus 100 may be in an engaged position (FIG. 4).

The second end 140 of the valve prop apparatus 100 (see FIGS. 9A, 9B) may include at least one protrusion 150, including without limitation, at least 1, 2, 3, 4, 5, 6, 7, 8, 9, and at least 10 protrusions 150. The number of protrusions 150 may be dependent on the type of adapter and/or type of respirator. The number of protrusions 150 may be dependent on the type of valve to be opened. Thus, the apparatus 100 may include a first protrusion, a second protrusion, a third protrusion, a fourth protrusion, and the like. The protrusions of the valve prop apparatus need not be uniformly spaced from one another, as the protrusions may be different distances from each to increase the likelihood of the valve prop apparatus fitting into the valve housing cross sections of a respirator.

The at least one protrusion 150 may include a point 155, wherein the point 155 may penetrate a valve to open the valve (FIG. 9B). The point 155 may be any shape or configuration capable of penetrating a valve of a respirator, including, but not limited to, ball-point or rounded, sharp, any combination thereof, or the like. The shaft 165 of the at least one protrusion may be of any shape or configuration capable of forming a tip capable of penetrating a valve of a respirator.

The apparatus 100 may include protrusions 150 of different lengths. As a non-limiting example, the first protrusion may include a length different than the second protrusion. The apparatus 100 may include protrusions 150 having the same length.

The at least one protrusion 150 may include a length of 1 mm to 50 mm. The at least one protrusion 150 may include any length capable of penetrating the valve of a respirator to open the valve. The at least one protrusion may include a length of at least 1 mm, including but not limited to at least 1 mm, 2 mm, 5 mm, 10 mm, 15 mm, 20 mm, 25 mm, 30 mm, 35 mm, 40 mm, 45 mm, and at least 50 mm. The at least one protrusion may include a length of no more than 50 mm, including but not limited to 45 mm, 40 mm, 35 mm, 30 mm, 25 mm, 20 mm, 15 mm, 10 mm, 5 mm, 2 mm, and 1 mm. Any combination of lower and upper limits is possible, including, but not limited to, 1 mm to 5 mm, 1 mm to 10 mm, 1 mm to 15 mm, 1 mm to 20 mm, 1 mm to 25 mm, 1 mm to 30 mm, 1 mm to 40 mm, 1 mm to 50 mm, 1 mm to 5 mm, 5 mm to 10 mm, 10 mm to 15 mm, 15 mm to 20 mm, 20 mm to 25 mm, 25 mm to 30 mm, 30 mm to 35 mm, 35 mm to 40 mm, 40 mm to 45 mm, and 45 mm to 50 mm.

The apparatus 100 may be of any shape, circumference, or length capable of allowing the apparatus 100 to rotate clockwise or counterclockwise until the at least one protrusion 150 engages a valve, valve housing, or cross section within valve housing of a respirator. The apparatus 100 may be of any shape, circumference, or length capable of allowing the apparatus 100 to rotate at least 45 degrees clockwise or counterclockwise with respect to the valve of a respirator. When the first end 110 of the apparatus 100 is in an engaged position, the apparatus 100 may be capable of rotating clockwise or counterclockwise until the at least one protrusion 150 engages to open the valve.

The apparatus 100 may rotate clockwise or counterclockwise until the at least one protrusion engages the valve and the shaft 165 or point 155 of the apparatus 100 contacts one or more partitions or spokes extending radially from a central axis of a valve. The contact of the at least one protrusion and the one or more partitions or spokes opens and holds the valve in an engaged (e.g., open) position.

The adapter 10 of the present disclosure may be of any shape, cavity circumference, depth, or length capable of allowing the apparatus 100 to rotate clockwise or counterclockwise until the at least one protrusion 150 engages the valve to open the valve.

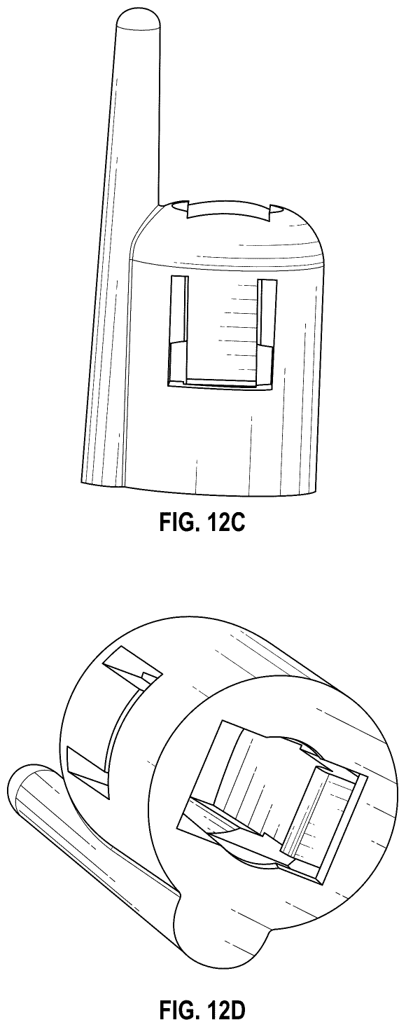

While the male post 130 may be centrally located within the cavity, it is possible and within the scope of the present disclosure that the male post 130 may be located at any position within the adapter that allows the apparatus 100 to rotate at least 45 degrees until the at least one protrusion engages the valve. As a non-limiting example, the male post 130 may be located on the interior housing of the adapter (see FIGS. 12A and 12B, wherein FIGS. 12C and 12D are an exemplary apparatus).

The apparatus 100 may rotate at least 45 degrees, including without limitation, at least 45, 90, 120, 150, 180, 210, 240, 270, 300, 330, and at least 360 degrees. The apparatus 100 may rotate not more than 360 degrees, including without limitation, not more than 330, 300, 270, 240, 210, 180, 150, 120, 90, 60, and not more than 45 degrees. Any combination of lower and upper limits may define the rotation of the apparatus 100, such as, 45-360 degrees, 45-300 degrees, 60-240 degrees, 45-90 degrees, 90-120 degrees, 120-150 degrees, 150-180 degrees, 180-210 degrees, 210-240 degrees, 240-270 degrees, 270-300 degrees, 300-330 degrees, 330-360 degrees, and the like. The degree of rotation may depend on the size, shape, and/or type of adapter, respirator, and/or valve. The degree of rotation may depend on the size or number of partitions or spokes of the valve. The degree of rotation may further depend on the size, shape, and/or size of male post capable of receiving the apparatus.

The apparatus 100 may perform at least 1 rotation, including, but not limited to at least 1, 2, 3, 4, 5, 6, 7, 8, 9, and at least 10 rotations.

The present disclosure provides an adapter 10 for a respirator including a male post 130 within the opening of the adapter. The adapter may be attached to the valve of the respirator.

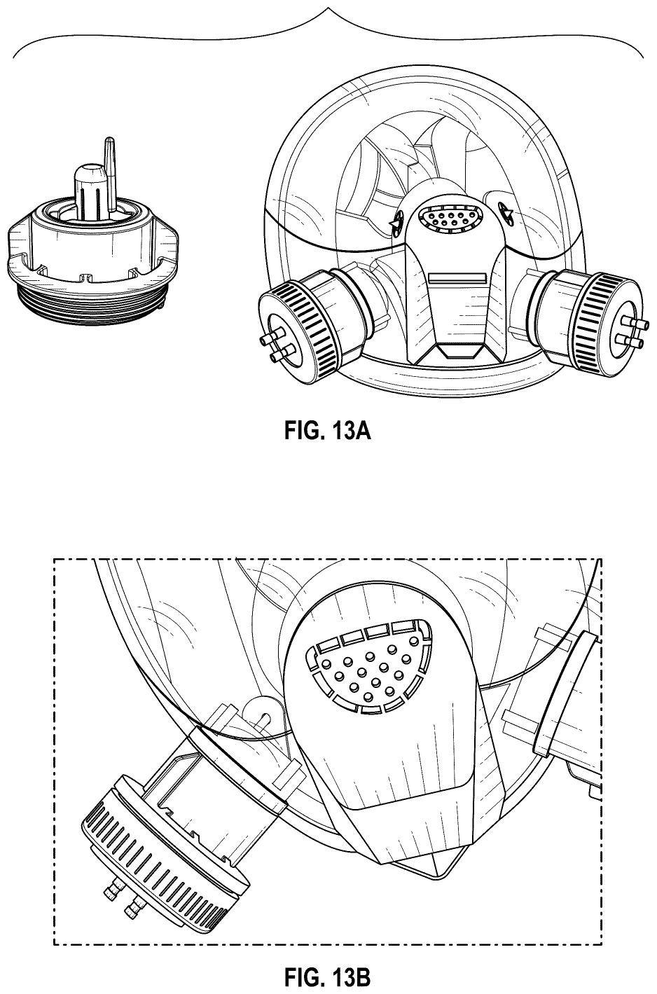

The first adapter end 300 may include male or female threads 310 capable of threadedly attaching to female or male threads of a respirator opening containing a valve so that the at least one protrusion 150 of the apparatus 100, when engaged with the adapter 10, is directed towards the valve of the respirator. The first adapter end may be screwed onto a respirator to removably attach the adapter to the respirator in order to open the valve according to the present disclosure (see FIGS. 13A-13B). While male and female threads have been described, other means of connecting two pieces are possible and within the scope of the present disclosure.

The adapters of the present disclosure may create a seal once attached to the respirator to prevent unwanted leakage when the apparatus engages the valve (see FIGS. 13A-13B). Adapters of the present disclosure may further include at least one cavity 175 for receiving a respirator tubing (FIGS. 12A-12B). The cavity 175 may include an opening configured to receive a fitting (FIG. 13A). The fitting may be configured to receive an end of respirator tubing.

The present disclosure also provides a converter for a respirator adapter. Existing adapters may not include all components necessary to function with an apparatus 100 of the present disclosure. Thus, a converter may convert an existing adapter into an adapter of the present disclosure. As such, a converter, as used herein may include all of the features and functionalities of adapters that provide connection to the presently disclosed apparatus 100.

The converter of the present disclosure may removably attach to an existing adapter for a respirator. As used herein, a “female thread” refers to at least one groove on the inside of converter or adapter. As used herein, a “male thread” refers to at least one groove externally placed on a converter or adapter. The converter may include a raised bearing ring at a distal end of the converter.

The converter may include a first converter end and a second converter end. The first converter end may include female threads capable of threadedly attaching to male threads on an opening of an existing adapter or male threads capable of threadedly attaching to female threads on an opening of an existing adapter. While female and male threads are described, other means of attaching a converter to an adapter are possible and within the scope of the present disclosure.

The second converter end may include the apparatus 100 and male post 130 of the present disclosure. The second converter end may include male threads capable of threadedly attaching to female threads of a respirator opening containing a valve so that the at least one protrusion of the apparatus is directed towards the valve of the respirator. The second converter end may be screwed onto a respirator to removably attach the adapter having a converter to the respirator in order to open the valve according to the present disclosure. While male and female threads have been described, other means of connecting two pieces are possible and within the scope of the present disclosure.

The second converter end may include an opening wherein the apparatus may be inserted on the male post. The opening may be of any shape necessary to conform to the shape of the valve to be opened. As a non-limiting example, the opening may be circular. The size, shape, and orientation of the opening of the adapter may depend on the size, shape, and orientation of the valve, valve housing, or valve cross-sections.

A converter having a male post and apparatus of the present disclosure may be screwed or threadedly attached to an adapter known in the art for any respirator size or any respirator type. Other types of removable attachments are possible and within the scope of the present disclosure, as the type of removable attachment may depend on the adapter and/or respirator. Accordingly, the present disclosure provides methods and devices for converting a prior art adapter to an adapter of the present disclosure by threadedly attaching the first end of a converter having an apparatus and male post of the present disclosure to a prior art adapter.

The shape and dimensions of the adapter and/or converter may depend on the type of respirator and/or type of adapter. One of ordinary skill in the art may readily determine the shape and dimensions of a converter for a particular respirator or adapter.

The present disclosure provides a method of opening a valve of a respirator for respirator fit testing. The method may include obtaining an adapter for respirator fit testing. The adapter may be an adapter of the present disclosure and may include an apparatus and male post according to the present disclosure. The adapter may be an existing adapter and may be used with a converter having an apparatus and male post according to the present disclosure.

The method may include threadedly attaching the adapter or adapter having a converter to the respirator, including causing the apparatus to rotate axially with respect to a longitudinal axis of the adapter or converter according to the present disclosure until the at least one protrusion engages the valve. The apparatus 100 may rotate counterclockwise or clockwise around the male post until the at least one protrusion is inserted into the valve to engage the valve and hold the valve in an open position. The method may include donning or putting on the respirator and performing a respirator fit test. Performing the fit test may include performing a controlled negative pressure fit test.

The apparatus 100 of the present disclosure may rotate independently of the male post, adapter, and converter. Once the apparatus opens the valve in the engaged position, the male post, adapter, and converter are capable of continuing to rotate even after the valve is engaged until the adapter and/or converter including a male post are threaded onto the respirator. The apparatus 100 remains engaged with the valve as the adapter and/or converter are threaded onto the adapter. The independent rotation of the apparatus 100 prevents destruction of the apparatus and/or the partitions or spokes of the valve. Conventional valve prop apparatuses may not rotate independently of the adapter, causing destruction of the apparatus or valve due to the pressure created from threading an adapter onto the respirator.

After the at least one protrusion engages the valve, the at least one protrusion of the apparatus may hold open the valve until the at least one protrusion is removed from the valve. Once a respirator fit test is completed, the method may include threadedly removing the adapter or adapter having a converter from the respirator, causing the at least one protrusion to disengage from the valve by rotating or threadedly removing in a direction necessary to disengage the at least one protrusion from the valve. The opening of the valve may be facilitated by the engagement of the at least one protrusion with the valve and does not require the platform or any other element of the apparatus to contact with the valve.

The at least one protrusion may locate at least one partition or spoke of the valve. As the adapter and/or adapter having a converter is threadedly attached, vertical downward threading pressure may automatically open the valve.

The apparatus of the present disclosure may open a valve of a respirator for the time necessary to set up and complete a respirator fit test. Thus, the apparatus may open a valve of a respirator as long as the adapter is threadedly attached to the respirator and engaging the at least one protrusion with the valve, including but not limited to, temporarily or permanently.

The present disclosure provides methods of manufacturing an apparatus of the present disclosure, a converter of the present disclosure, and an adapter of the present disclosure. Methods of manufacturing may include, but are not limited to, 3-Dimensional printing, laser printing, sintering, Computer Numerical Control (CNC) machining, and injection molding. Other manufacturing methods are possible and within the scope of the present disclosure.

The apparatus, converter, and/or adapter of the present disclosure may include any material or a combination of materials sufficient to provide adequate structural properties, including, but not limited to sufficient stiffness and deformability to perform the methods of the present disclosure. The material or combination of materials may include polylactic acid, acrylonitrile butadiene styrene, plastic, polyvinyl alcohol plastic, polycarbonate, alumide, polyamide, resin, high-detail resin, paintable resin, transparent resin, stainless steel, aluminum, bronze, nickel, titanium, carbon fiber, graphene, nitinol, paper, polyvinyl chloride, any combination thereof, and the like.

The present disclosure provides a kit including one or more of an adapter, a valve prop apparatus of the present disclosure, and/or a converter of the present disclosure. The kit may include a prior art adapter and/or an adapter of the present disclosure having a male post. The kit may include written instructions on methods of installation of the components on a respirator in preparation for a respirator fit test.

Conventional valve prop apparatuses and methods of opening a valve of a respirator for respirator fit testing require manual assertion of an apparatus into the valve. Insertion may be difficult for a user who does not have specialized expertise with respirator fit testing and/or valves of a respirator. Thus, conventional apparatuses and methods may result in improper placement of the apparatus in the valve. Conventional apparatuses and methods may result in an increased likelihood for the apparatus to fall out and fail to hold open the valve. It is important during respirator fit testing to temporarily open a valve to ensure continuous air flow during a fit test. If a valve is not temporarily opened, the valve will close during testing, and the test will most likely fail or abort. Thus, conventional apparatuses and methods may result in an increased number of unnecessary failures of a respirator fit test.

With manual valve propping methods, the valve prop apparatus is often forgotten and left in by accident. When this occurs, the respirator does not function properly as the exhalation valve is open and becomes an inhalation source. This exposes the individual to unfiltered air, which may be dangerous or result in improper fit testing. The apparatus of the present disclosure eliminates these problems known in the art by ensuring removal of the valve prop apparatus.

Conventional methods of performing a fit test include removing the valve for respirator fit test. Removing the valve may disturb the fit of the respirator after a fit test is performed and the valve is replaced. Removing the valve from the respirator prior to performing a fit test may damage the valve.

Unlike conventional apparatuses and methods, the present disclosure enables a user without any prior experience to open a valve of a respirator in preparation for respirator fit testing using the apparatus and methods of the present disclosure. The engagement of the apparatus and valve when the adapter and/or converter are removably attached to the respirator enables the opening of the valve with minimal user interaction. Thus, a user of the apparatus and methods of the present disclosure is not required to touch the apparatus during insertion into the valve, as the valve is opened by removably attaching the adapter and/or converter having the apparatus to the respirator in order to engage the at least one protrusion with the valve. The apparatus, adapter, converter, and methods of the present disclosure provide an improved mechanism of action, which may solve one or more of the shortcomings in the conventional art. The apparatus, adapter, converter, and methods of the present disclosure may eliminate any potential interference with the respirator's valve architecture.

Since the apparatus may rotate freely counterclockwise or clockwise around the male post until the at least one protrusion is engaged with a partition or spoke of the valve, the present disclosure enables the apparatus to rotate until the at least one protrusion is engaged with the valve. Once in an engaged position, the apparatus may not rotate counterclockwise or clockwise around the male post as the adapter and/or converter are threadedly attached to the respirator. As the adapter and/or converter are threadedly removed from the respirator, the apparatus may disengage the valve and rotate counterclockwise or clockwise so the protrusion is not in contact with the partition or spoke of the valve, allowing the apparatus to disengage and remove from the valve.

The present disclosure prevents the apparatus from inadvertently falling from or inadvertently being removed from the valve during set up and performance of a respirator fit test. The present disclosure prevents improper placement of the apparatus, as the male post is positioned at the appropriate height, depth, and diameter from the center of the adapter or converter opening having the male post. Thus, once the apparatus is removably attached to the male post of the adapter according to the present disclosure, the apparatus is at the appropriate distance and location to ensure that the at least one protrusion is capable of engaging the valve to hold the valve in an open position. Thus, the adapter and/or converter may include the apparatus to ensure an integrated method to open the valve at the same time that the adapter and/or converter is attached to the respirator. The action of removably attaching the adapter or adapter having a converter to the respirator and the action of the apparatus rotating to open the valve until reaching an engaged position may occur independently and simultaneously.

### Aspects

Aspect 1: A system for opening a valve of a respirator for respirator fit testing, comprising an apparatus that includes: a first end, wherein the first end comprises a cavity or central bore, wherein the cavity is configured to receive a male post of an adapter; a second end, wherein the second end comprises at least one protrusion; and an internal flange, wherein the internal flange comprises an interlocking feature, wherein the interlocking feature is configured to interact with at least one circumferential groove spaced axially along the male post to establish at least one adjustable height of the at least one protrusion; wherein the apparatus rotates clockwise or counterclockwise until the at least one protrusion is engaged with the valve, a valve housing, or a cross section within housing.

Aspect 2: The system according to any of the foregoing aspects, comprising an adapter comprising the male post, wherein the male post comprises three circumferential grooves spaced axially along the male post.

Aspect 3: The system according to any of the foregoing aspects, wherein the at least one adjustable height comprises a first position, wherein the first position comprises a circumferential groove distally located on the male post.

Aspect 4: The system according to any of the foregoing aspects, wherein the at least one adjustable height comprises a second position, wherein the second position comprises a circumferential groove centrally located on the male post.

Aspect 5: The system according to any of the foregoing aspects, wherein the at least one adjustable height comprises a third position, wherein the third position comprises a circumferential groove proximally located on the male post.

Aspect 6: The system according to any of the foregoing aspects, wherein the adapter comprises a raised bearing ring at a distal end of the adapter.

Aspect 7: The system according to any of the foregoing aspects, wherein the male post is part of a converter attachable to the adapter.

Aspect 8: A method of opening a valve of a respirator for respirator fit testing, the method comprising: obtaining an adapter for respirator fit testing, wherein the adapter comprises a converter having a male post; inserting an apparatus onto the male post, wherein the apparatus comprises a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position of the apparatus on the male post; attaching the adapter to the respirator, wherein attaching the adapter to the respirator comprises applying a pressure, wherein the apparatus rotates at least 45 degrees counterclockwise or clockwise, and wherein the at least one protrusion is inserted into the valve to open the valve; donning the respirator; and performing the respirator fit test.

Aspect 9: The method according to any of the foregoing aspects, wherein the male post comprises three circumferential grooves spaced axially along the male post.

Aspect 10: The method according to any of the foregoing aspects, wherein the at least one position comprises a first position, wherein the first position comprises a circumferential groove distally located on the male post.

Aspect 11: The method according to any of the foregoing aspects, wherein the at least one position comprises a second position, wherein the second position comprises a circumferential grove centrally located on the male post.

Aspect 12: The method according to any of the foregoing aspects, wherein the at least one position comprises a third position, wherein the third position comprises a circumferential grove proximally located on the male post.

Aspect 13: The method according to any of the foregoing aspects, wherein the converter comprises a raised bearing ring at a distal end of the converter.

Aspect 14: The method according to any of the foregoing aspects, the method further comprising engaging the apparatus at the at least one position according to a specific respirator.

Aspect 15: A method of opening a valve of a respirator for respirator fit testing, the method comprising: inserting an apparatus onto a male post of an adapter for respirator fit testing, wherein the apparatus comprises a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position; attaching the adapter to the respirator, wherein attaching the adapter to the respirator comprises applying a pressure, wherein the apparatus rotates at least 45 degrees counterclockwise or clockwise, and wherein the at least one protrusion is inserted into the valve to open the valve; donning the respirator; and performing the respirator fit test.

Aspect 16: A kit comprising: an adapter for respirator fit testing; a converter having a male post, wherein the converter removably attaches to the adapter; and an apparatus comprising a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position.

Aspect 17: A kit comprising: an adapter having a male post, wherein the adapter removably attaches to a respirator; and an apparatus comprising a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position.

What is claimed is:

1. A system comprising an apparatus having:
a first end, wherein the first end comprises a cavity, wherein the cavity is configured to receive a male post of an adapter;
a second end, wherein the second end comprises at least one protrusion; and
an internal flange, wherein the internal flange comprises an interlocking feature, wherein the interlocking feature is configured to interact with at least one circumferential groove spaced axially along the male post to establish at least one adjustable height;
wherein the apparatus is configured to rotate clockwise or counterclockwise about the male post until the at least one protrusion is engaged with a valve of a respirator, a valve housing, or a cross section within the valve housing.

2. The system of claim 1, comprising:
an adapter having a male post, wherein the male post comprises three circumferential grooves spaced axially along the male post.

3. The system of claim 2, wherein the at least one adjustable height comprises a first position, wherein the first position comprises a circumferential groove distally located on the male post.

4. The system of claim 2, wherein the at least one adjustable height comprises a second position, wherein the second position comprises a circumferential groove centrally located on the male post.

5. The system of claim 2, wherein the at least one adjustable height comprises a third position, wherein the third position comprises a circumferential groove proximally located on the male post.

6. The system of claim 1, wherein the adapter comprises a raised bearing ring at a distal end of the adapter.

7. A method of opening a valve of a respirator for respirator fit testing, the method comprising:
inserting an apparatus onto a male post of an adapter for respirator fit testing, wherein the apparatus comprises a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position; and
attaching the adapter to the respirator, wherein attaching the adapter to the respirator comprises applying a pressure, wherein the apparatus rotates at least 45 degrees counterclockwise or clockwise, and wherein the at least one protrusion is inserted into the valve to open the valve.

8. The method of claim 7, wherein the male post comprises three circumferential grooves spaced axially along the male post.

9. The method of claim 8, wherein the at least one position comprises a first position, wherein the first position comprises a circumferential groove distally located on the male post.

10. The method of claim 8, wherein the at least one position comprises a second position, wherein the second position comprises a circumferential grove centrally located on the male post.

11. The method of claim 8, wherein the at least one position comprises a third position, wherein the third position comprises a circumferential grove proximally located on the male post.

12. The method of claim 7, wherein the converter comprises a raised bearing ring at a distal end of the converter.

13. The method of claim 7, the method further comprising engaging the apparatus at the at least one position according to a specific respirator.

14. A kit comprising an adapter and apparatus according to the system of claim 2.

15. A kit comprising:
an adapter for respirator fit testing;
a converter having a male post, wherein the converter removably attaches to the adapter, and
an apparatus comprising a first end, wherein the first end comprises a cavity, wherein the cavity is configured to receive the male post; a second end, wherein the second end comprises at least one protrusion; and an internal flange, wherein the internal flange comprises an interlocking feature, wherein the interlocking feature is configured to interact with at least one circumferential groove spaced axially along the male post to establish at least one position.
